(19) United States
(12) Patent Application Publication
(10) Pub. No.: US 2009/0228911 A1
(43) Pub. Date: Sep. 10, 2009

(54) TV CONTROL ARBITER APPLICATIONS

(75) Inventor: Alexander P.P. Vrijsen, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,848

(22) PCT Filed: Dec. 5, 2005
(86) PCT No.: PCT/IB05/54051

§ 371 Date: Jun. 5, 2007

Related U.S. Application Data
(60) Provisional application No. 60/633,972, filed on Dec. 7, 2004.

(51) Int. Cl. H04N 7/16; H04N 5/44; H04N 7/173

(52) U.S. Cl. 725/14; 725/25; 348/734; 725/24; 348/E05.096

(57) ABSTRACT

An application for making the shared use of a media system (100), including a television (140), more fun while democratizing the decision making process among the users, and involving the users more closely in the television experience. In one aspect, control of the media system is granted to one of the users in a group based on, e.g., personal information of the users (335), a game (340), a vote (345), an arbitrary selection (350), or the first user to respond to a prompt (355). In another aspect, the application automatically initiates a vote (415) in which the users vote for a desired channel, and the application switches the television to the channel that received the most votes (440). In another aspect, users are allotted a balance of commands (500), and the remaining balance of commands is tracked (510) and displayed (515) on the television.

The invention relates generally to an application for granting control of a media system such as a television to a user when a group of users are together, such as by running a contest in which the winner is granted control, e.g., to change the channel of the television.

In many households, a media system including a television, possibly combined with a set-top box, digital versatile disk (DVD) player, and/or video game console, for instance, plays a central role in the family. Often, multiple persons use it simultaneously, such as by viewing a broadcast program, a program such as a movie stored on a local storage device, e.g., DVD, or participating in a video game which is displayed on the television screen or other display, such as a computer screen. However, the person who has the most authority in the family usually controls the television. This holds for selection of the channel, for control of applications, such as active or downloaded applications, and for control of the television settings, such as volume, for instance.

When different people want to use the television at the same time, they have to agree which channel will be played, and/or which person will control the applications and settings. Choosing the channel to watch or assigning control of an application can be a source of contention in the family. Another result can be that everyone goes his or her own way to view another television, thereby ending the social experience.

The present invention addresses the above and other issues by providing an interactive arbiter application that arbitrates control of a media system among a number of competing users. The application can determine which user is granted control of the television in a number of ways. The application can also increase interest among users in a media system in which content is available on a plurality of channels by automatically initiating a vote that allows the responding users to change the channel to view a different program. In another aspect, the application can allot a number of commands to each user, and track the remaining balance. The application therefore can make the shared use of the media system more fun while democratizing the decision making process among the users, and involving the users more closely in the television experience.

In particular, in one aspect of the invention, a method for assigning control of a media system includes initiating an arbitration among users of the media system, determining which of the users is a winner of the arbitration, and granting control of at least one function of the media system to the user that is the winner of the arbitration. The arbitration can be any process for deciding the winner, and may occur internally to the media system, requiring no input from the users, or may involve inputs from the users, such as in a direct competition.

In another aspect of the invention, a method is provided for increasing interest among a plurality of users in a media system in which content is available on a number of channels. The method includes automatically initiating a vote in which the users are prompted by the media system to vote for a favorite channel, tallying the votes to determine which of the channels won the vote, if any, automatically switching the media system to the channel that won the vote, if any, responsive to the tallying, and maintaining the media system on a current channel if none of the plurality of channels won the vote.

In yet another aspect of the invention, a method for tracking interaction with a media system by users includes displaying respective balances, on the display of the media system, indicating respective allotments of commands which are allotted to each of the users for controlling the media system, tracking commands provided by the users, and updating the displaying of the respective balances according to the tracking of the commands to display a respective remaining balance of the respective allotment of commands for each of the users.

Corresponding systems and program storages devices are also provided.

In the drawings:

In all the Figures, corresponding parts are referenced by the same reference numerals.

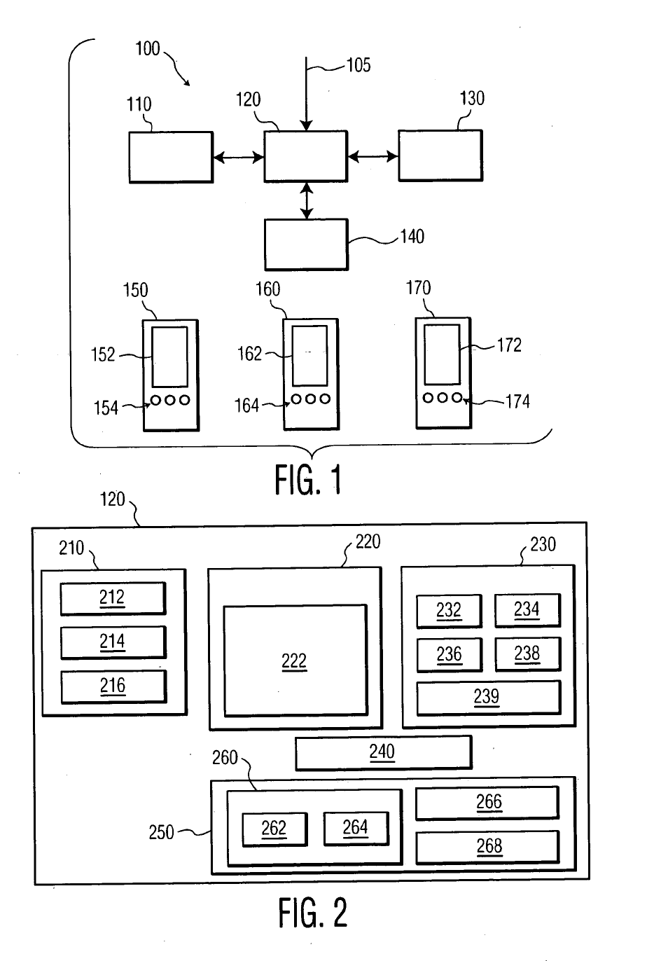

FIG. 1 illustrates a media system that can be controlled by different remote control devices, according to the invention;

FIG. 2 illustrates a set-top box in a media system, according to the invention;

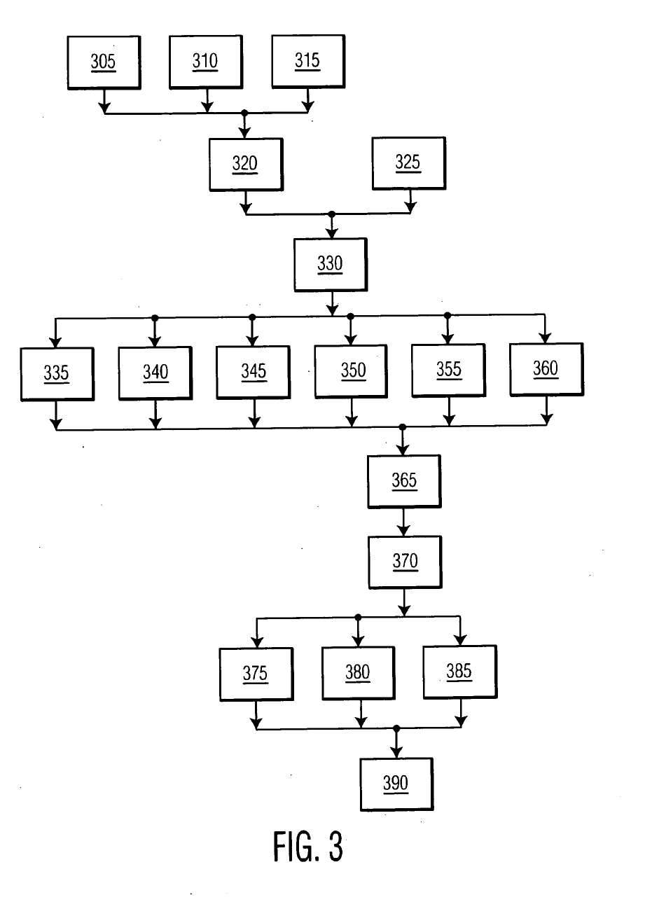

FIG. 3 illustrates a process for granting control of a media system to a user, according to the invention;

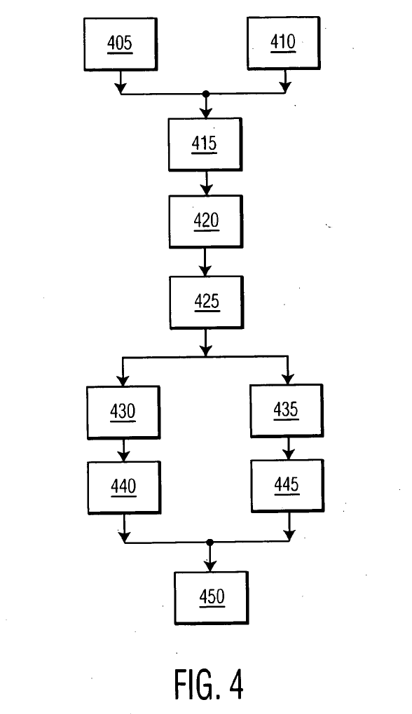

FIG. 4 illustrates a process for automatically implementing a vote to allow users to change a channel of a media system, according to the invention; and

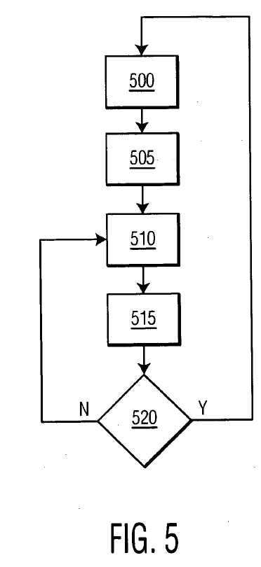

FIG. 5 illustrates a process for maintaining a balance of commands that a user has remaining for controlling a media system, according to the invention.

The invention relates generally to media systems such as those which include digital televisions, set-top boxes, digital versatile disk (DVD) players, video game consoles, including those that provide a platform that allows for downloading of applications. The invention may be used as well with any other consumer electronics devices that have multiple users.

FIG. 1 illustrates a media system that can be controlled by different hand held remote control devices, according to the invention. The media system 100 includes a DVD player 110, set-top box 120, video game console 130 and display device 140, such as a television. The set-top box 120 may receive input signals such as broadcast television signals via an input path 105. The set-top box 120 may also route signals from the DVD player 110 and video game console 130 to the display 140, although it is also possible for the DVD player 110 and video game console 130 to communicate directly with the display 140.

Remote control devices may be used by each user of the media system 100. For example, handheld remote control devices 150, 160 and 170 may be used by respective users. In one possible approach, the remote control devices 150, 160 and 170 can be programmed to interact with the application of the present invention, e.g., via special keys, while also providing conventional commands for controlling the media system. The remote control devices may be integrated into another device as well. For example, Palm operating system handheld device such as the Philips Pronto are available for controlling media devices via an infrared port. Furthermore, it is expected that mobile telephones will be provided with the capability to act as remote control devices for media systems.

In some cases, each remote control device 150, 160 and 170 device will send a slightly different remote control command for the same key press/command, so that the application can distinguish between different users and their remote control devices. In another possibility, the set-top box 120 can distinguish signals of the different remote control devices based on characteristics of the signals such as direction/angle of transmission and signal strength.

The remote control devices 150, 160 and 170 may transmit infrared signals that are received by the set-top box 120 or other system under control. For instance, the signals may be commands to change the channel that is tuned and displayed on the display 140, adjust the volume or display settings, or start or stop the playing of stored content. It may also be possible for the set-top box 120 to transmit signals to the remote control devices 150, 160 and 170 in a two-way communication scheme. The remote control devices 150, 160 and 170 may have display touch screens 152, 162 and 172, which are configured to display images of buttons that can be selected by the user for providing commands. Physical buttons 154, 164 and 174 may also be provided.

FIG. 2 illustrates a set-top box 120 in a media system, according to the invention. While the invention can be used with any remotely controlled system, discussion of a set-top box embodiment is illustrative. The concepts shown can be extended to other systems as will be apparent to those skilled in the art. Generally, the set-top box 120 provides functions including signal reception and demodulation, signal processing, audio and video output and a user interface. A channel decoding function 210 includes front ends 212, 214 and 216 for receiving satellite, terrestrial and cable signals, respectively. A source decoding function 220 handles media and control processing. For example, a media processor 222 based on the Philips Semiconductor PNX8500 may be used. An audio function 230 includes an audio digital-to-analog converter (DAC) 234 for sound processing; with further digital audio integrated circuits (ICs) available to process multi-channel audio broadcasts. An analog-to-digital converter (ADC) 232 digitizes analog signals, while coders/decoder (CODECs) 236 may process audio from the DVD player 110 or video game console 130. Audio amplifiers 238 provided amplified audio signals, while a sound processing function 239 may provide processing such as for surround sound audio. An RF modulator 240 provides an analog TV signal for the television 140 or other display device. Interfaces 250 such as an IEEE1394 A/V link layer IC 262 and a physical layer IC 264 can be included to provide high-bandwidth, high-speed real-time communication with other multimedia devices and peripherals. A USB interface IC 266 allows the set-top box 120 to interface with the video game console 130 and other devices such as a digital camera, mobile phone, MP3 player, or PDA, for instance. A smart card reader 268 may be used to authorize pay services such as pay television applications.

Referring also to FIG. 1, regardless of the implementation of the media system 100, an interactive arbiter application according to the invention can be run using executable instructions such as software, firmware and/or micro-code stored at the media system, in one possible approach. The media system 100 may include memory and processing resources for implementing the interactive application. A memory that stores the instructions may be considered a program storage device. In particular, at least one program storage device may tangibly embody the instructions that are executed by at least one processor to achieve the functionality described herein. In one possible approach, additional data for implementing the application can be received in the television broadcast, for example. For instance, the application may generate template displays using locally stored data that are filled in using data provided in the television broadcast, or via another path such as the Internet. In another approach, all data for implementing the application is stored locally, e.g., in the media system 100 or in another storage device.

The arbiter application can designate the user that is allowed to control the application, and determine the period for which this decision holds. If the media system 100 is operated via a single handheld remote control device, the application decides which user is allowed to use the remote control device. If the system is operated via multiple handheld remote control devices operated by respective users, the application can enable and disable all or part of the devices, such as by enabling or disabling groups of keys on the devices. Various techniques for communicating with remote control devices to enable and/or disable their functions can be used. For example, U.S. published patent application no. 2002/0101358, published Aug. 1, 2002, and incorporated herein by reference, discloses a technique for transmitting code data from a set-top box to a remote control device. This concept can be extended to transmit data for enabling, disabling or otherwise configuring a remote control device to achieve the functionality discussed herein. U.S. Pat. No. 6,774,813, issued Aug. 10, 2004, incorporated herein by reference, also provides a technique for programming a remote control device. U.S. patent application Ser. No. 09/393,942, filed Sep. 10, 1999, to John Bell, (docket no. PHA-23-773), incorporated herein by reference, (equivalent published as WO 01/20572 A1 on Mar. 22, 2001), provides a technique for remotely controlling an electronic device using a mobile station.

Generally, a two-way communication can be provided between a set-top box or other system under control and a remote control device. For instance, the application could partially disable a remote control. To illustrate, in case of a simple multi-user game, some users can be allowed to use navigation keys and numbers, but not the volume key, while a selected user is granted the authority to use all features. Thus, the application can enable or disable certain groups of keys depending on the mode of operation or other application(s) that are running. The remote control device 150, 160 and 170 can also inform the user that certain keys are inactive, such as by emitting a beep, when the user presses the keys. Or, the media system 100 can provide feedback on the remote control keys that are ignored, such as by displaying a message or audible tone when a command is received but is not executed.

Or, without the need for two-way communications, the application can ignore the commands from all of the devices except one, thereby allowing the user of the selected device to enter commands without interference from the other users. Generally, the application can ignore commands received from some or all of the keys on a remote control device. Thus, commands from some or all of the keys on the remote control device can be disabled in the remote control device itself or in the media system 100 or other system under control.

Applications that will make use of such remote control devices can be part of the product that is controlled or they can, for instance, be stored on a disc (compact disk (CD)/(Blu-ray Disk-Read Only Memory BD-ROM)) or broadcasted together with a TV (or radio) show (the latter ones will be called external applications, like games, electronic program guides (EPGs), interactive commercials etc.). In order to manage all this, an arbiter is desired and a standard API is desired for external applications. The application may run all the time, and it can be configured dependent on the mode of operation of the media system. By default, it could accept all commands, but the user can also configure the arbiter application to accept only commands from a certain remote control, or to go into one of several arbitration modes, discussed further below. In an arbitration mode, it can start arbitration, when it receives similar commands from multiple remote control devices within a certain time interval, which can also be configurable, in response to a user pressing a button on the remote control device to prompt a conflict, or at other times. Via the standard API mentioned above, external applications can enable/disable certain keys from users whenever they like.

The application can be an integral part of the media system 100 or it can be downloaded if the media system supports an application platform such as Java, Multimedia Home Platform (MHP), OpenCable™ Application Platform (OCAP™), or ARID.

Generally, the application can communicate with the users by displaying on-screen messages and/or via audio messages, such as recorded or synthesized voice messages. The users communicate with the application via their remote control devices. The specific details of the application depend largely on the context in which it is used. Therefore the behavior should be configurable.

FIG. 3 illustrates a process for granting control of a media system to a user, according to the invention. The application can base its decision of which user will be granted control of the media system based on various criteria. In one approach, a arbitration among users of the media system can be initiated automatically by the media system, e.g., without any user input. Or, the arbitration can be initiated by one or more of the users. The arbitration can test the knowledge or skill of the users, for instance.

Block 320 reads “application initiates an arbitration”. This can be based on, e.g., a “timer” (block 305), so that an arbitration is initiated after a given amount of time has passed while the media system is being used, such as after every one hour of television viewing. In another approach, a “random number generator” (block 310) is used to initiate the arbitration at essentially random times. This approach may include random, e.g., arbitrary, time within certain bounds, such as arbitrarily between one and two hours of television viewing. In a “conflict detected” approach (block 315), the application determines when two or more users have provided conflicting commands to the media system. For example, this may include commands to change the channel from the two or more users within a defined time period, e.g., one minute. In this approach, the commands from the remote control device of the different users can be associated with the respective users, such as through a learning or set-up process. The commands may be coded to identify the user, or the user may be identified based on a position and strength of the received signal.

Alternatively, the “user initiates an arbitration” (block 325). For example, a user can enter a command via a remote control device to directly challenge the other users to an arbitration.

Block 330 reads “Start arbitration”. The application may provide various types of arbitrations to decide which user is granted control of the media system. Block 335 reads “access users' personal information”. In this approach, each user provides personal information such as age and name to the application, such as via an on-screen display in a setup mode. Then, the application can choose which of the users is the winner based on the personal information. For example, the oldest user may be selected as the winner in a first arbitration, while the second oldest is selected as the winner in a next arbitration, and so forth. In another example, the winners in different arbitrations may be selected alphabetically based on their names. Or, age can be combined with the time of day, such that until 7:30 pm children are granted control, between 7:30 and 9:30 pm teenagers are granted control, and after 9:30 pm adults are granted control. As another example of using personal information, a user can be granted control of the media system for the entire day during the user's birthday. The personal information regarding the users can be entered into the application by the users in a setup mode via an on-screen interface, for example. The set-top box 120 can maintain the personal information in non-volatile storage. As a further example, the application may also consider information such as the number of times and/or the amount of time in the past that a user has been granted control of the media system in its decision so that there is a more equal chance for all users to be granted control. For instance, if there are four users, and three have been selected as winners previously, the fourth user can be selected as the winner in the current arbitration.

Generally, when the application detects that a new remote control device is being used, the application could ask the user for his or her name, once. If the origin of a remote control command is only determined by a scheme such as detecting the distance and/or angle from the remote control to the set-top box 120 (see WO 01/47247, published Jun. 28, 2001, incorporated herein by reference), the user should be requested for his or her name in each session since the locations of users can change between different sessions. It is also possible to identify voice-commands of a specific user based on voice recognition techniques. Depending on the voice characteristics, the system under control can determine which user gave the command, and again an arbiter application could distinguish between such commands. If the remote control device has the name of the user in its memory, it could automatically communicate the name to the application via remote control commands (and via the API to the external applications).

Block 340 reads “play game”. The users may use the remote control devices, or special gaming devices, such as those used for playing video games, to interact with the game. In this approach, any type of game, such as a quiz, mind game, puzzle, or the like is presented by the application. For example, the application may display one or more multiple choice questions to the users, to which the users enter their responses. The winner is then designated as the user with the most correct answers. The winner may be entitled to select a category of questions when the quiz is subsequently run to decide a subsequent arbitration for control of the media system. Or, the game may be a video game in which the users compete against one another such as by maneuvering figures around the screen.

The following describes an example quiz-based arbiter application, where every user has a remote control device, and the application is an integral part of the product, e.g., set-top box 120. In one approach, where the remote control devices can be configured by the application, the application disables all control keys on the remote control devices for all users, except those keys needed to interact with the arbiter application. This can be achieved, e.g., with a remote control device having a touch screen that displays selected keys. The application then asks a multiple-choice question, and the users that answer the question correctly get a point. The user that answers first gets full control (his keys are enabled). After ten minutes, the user that currently has control selects a category for the next question, and the process starts again. After each round, the user who has the most points gets control. After one hour or when the current television program ends, another user is randomly selected to select a category and all collected points are reset to zero.

In another possibility, the game details can depend on the currently selected channel and or program, and they can even be part of the broadcast content. For example, if the users are viewing a cartoon program, the game may feature a character from the cartoon. If the users are viewing a channel that features auto racing, the game may have an auto racing theme. Providing program or channel specific games can be achieved by using a game that is broadcast with a program, or selecting a game from a library of available games based on an identification of the channel and/or program being viewed. This may be done, e.g., using an electronic program guide, meta data or other techniques known to those skilled in the art. The games may be organized in the library based on different themes such as children's games, sports games, and so forth.

Note that the game can replace the normally broadcast program, or can be provided in a subset window or other display region, such as using picture-in-picture or a split screen, to allow continued viewing of the program. For a program that can be started and stopped, such as a recorded program, the application can stop the program to run the game. In another option, the game can be provided using nearly transparent displays to allow continued viewing of the program.

Block 345 reads “vote for user”. In this case, each user votes for another user, and the user that receives the most votes is the winner. If none of the users receives the most votes, e.g., there is a tie among multiple users, one or more runoff rounds may be completed among the top vote receivers. Or, the application may make a random selection among the users that are tied, or a selection based on the users' personal information, e.g., age. Or, the user that is currently in charge can continue.

Block 350 reads “arbitrarily select”. In this case, one of the users is arbitrarily selected as the winner based on, e.g., a random number generator.

Block 355 reads “display prompt—select first responder.” In this approach, the application provides an on-screen display such as “press 1 to be a winner”. The first user to press the “1” button on a remote control device is identified and selected as the winner. This encourages the users to be attentive to a program being watched.

Block 360 reads “display prompt—arbitrarily select from among responders.” In this approach, the application provides an on-screen display such as “press 1 before it is too late!” A timer may be implemented such that all users that press the “1” button on their remote control devices within a defined time limit, e.g., one minute, are considered as potential winners. The winner is selected arbitrarily from the users that respond within the time limit. A countdown time may be displayed to indicate the remaining time.

Block 365 reads “select winner”. Based on, e.g., any of the above-mentioned approaches, or combinations thereof, a winner is selected. Block 370 reads “grant control to winner.” The application grants control of at least one function of the media system to the winning user. Note that it is also possible to have teams or groups of users, in which case control is granted to the users on the winning team. For instance, a family may play with the children on one team and the parents on another team. Each user in the winning team is free to enter commands for controlling the television.

Furthermore, it is possible for some keys on the remote control devices to be enabled for multiple users. For example, in the case of a game (an external application), the game keys (e.g., left, right, up, down, fire) can be enabled for two players (winners), and keys to start/stop the game might be enabled for a third remote control device, such as that of a parent.

Control can be granted to the winner in various ways. For example, when the users share a common remote control device, the application can display a message indicating which user is the winner, and the users can comply with the message by handing over the remote control device to the winner. This is indicated by block 375, which reads “display name of winner.” For example, a small box with the name of the winner can be shown in a corner of the screen. This display can be maintained for the duration of the period in which the winner has control. Note that external applications might use the arbiter application in their own way and also display the winner in their own way.

Block 380 reads “configure remote control devices”. In this approach, the application causes a signal to be transmitted to one or more remote control devices of the users to enable and/or disable the remote control devices. For example, as mentioned previously, the remote control device of the winner can be enabled to transmit signals to control the media system. It is further possible to cause the winner's remote control device to respond such as by flashing or beeping to identify the winner. It is also possible to at least partially disable the remote control devices of the non-winning users, e.g., the losers.

Block 385 reads “filter out commands from losers”. In this approach, there is no need to configure the remote control devices. Instead, processing of the remote control devices, e.g., after their signals are received by the set-top box 120 is modified by filtering out some or all of the commands from the losers, while carrying out the commands from the remote control device of the winner. A learning or setup process can be used to recognize the remote control device and associated user of a received signal.

Block 390 reads “wait”. The winner of the arbitration may be granted control of the media system for a defined time period, such as one-half hour, after which another arbitration can be initiated.

FIG. 4 illustrates a process for automatically implementing a vote to allow users to change a channel of a media system, according to the invention. Block 415 reads “application initiates a vote”. The vote is initiated automatically by the media system, e.g., without any user input. Advantageously, since the users do not know when a vote will be initiated, they are encouraged to be attentive to a program being viewed so they do not miss the chance to vote. This can be based on, e.g., a “timer” (block 405), so that a vote is initiated after a given amount of time has passed while the media system is being used, such as after every one hour or so of television viewing. In another approach, a “random number generator” (block 410) is used to initiate the vote at random times. This approach may include random, e.g., arbitrary, initiations within certain bounds, such as arbitrarily between one and two hours of television viewing.

Block 420 reads “prompt users to vote for desired channel.” This may be achieved, e.g., by displaying an on-screen message or by an audio message. The display may inform the users how to vote, such as by entering the channel number that they desire to view using the keypad of their remote control device. The display may access an EPG to display the programs that are being shown on different channels. A time limit for voting may also be imposed by displaying a countdown timer. Block 425 reads “tally votes”. The application adds up the votes to see which of the channels won the vote, if any. A channel is declared the “winner” (block 430) if it received more votes than any other channel, and the application will “switch to winning channel” (block 440) by controlling the tuner of the set-top box 120, for instance. Otherwise, there is a “tie” (block 435) among the channels that received the same number of votes, and the application will “maintain current channel” (block 445). Block 450 reads “wait”. The winning channel is tuned for a defined time period, such as one-half hour, after which another vote can be automatically initiated.

Note that other voting processes can be used. For instance, the vote can be used to determine which user will control the teletext/closed captioning, the volume, a game, switching from TV watching to listening to music, and so forth.

FIG. 5 illustrates a process for maintaining a balance of commands that a user has remaining for controlling a media system, according to the invention. Block 500 reads “Allot defined number of commands to each user.” For example, each user may be allotted five commands, such as commands to change the channel. Block 505 reads “Display balances of users.” The application displays an on-screen balance for each user. This display can be at the bottom or top of the screen, for instance, so that it does not interfere with a program being viewed. Block 510 reads “Track commands provided by users.” The application keeps track of each command entered by the users using their remote control devices. The application can recognize which commands are received from which users using a setup or learning process, as mentioned previously. Block 515 reads “Update display to show remaining balances.” As the users enter commands, their balance is decreased, and the remaining balance is displayed. Block 520 reads “All allotments exhausted?” In one possible approach, the application waits until each user uses up their allotment before providing a new balance of commands for all users.

In a particular implementation, at the start, all remote control devices are active and each remote control device is allowed to perform a number of key presses. These numbers can be shown per user at the top of the screen in an “remote control (RC) credits status line” for a limited amount of time. When a user presses a key on his or her remote control device, the related command is executed, the number of key presses it has left is decreased by one, and the “RC credits status line” is shown for some time again. When all remote control devices are out of credits, the arbiter application assigns new credits. In one approach, the number of credits assigned can depend on personal information such as age, time, viewing/playing time history and the like.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for assigning control of a media system, comprising:
initiating an arbitration (320, 325) among a plurality of users of the media system (100);
determining which of the plurality of users is a winner of the arbitration; and
granting control (370) of at least one function of the media system to the user that is the winner of the arbitration.

2. The method of claim 1, wherein:
the winner is granted control of the at least one function of the media system for a defined time period (390), after which another arbitration can be initiated.

3. The method of claim 1, wherein:
the arbitration is initiated (320) by the media system.

4. The method of claim 1, wherein:
the arbitration is initiated by the media system when the media system determines that conflicting commands have been received (315) from at least two of the plurality of users.

5. The method of claim 1, wherein:
the arbitration is initiated (325) by at least one of the plurality of users.

6. The method of claim 1, wherein:
the arbitration comprises a vote (345) in which the plurality of users elect one of the plurality of users as the winner.

7. The method of claim 1, wherein:
the granting control of the at least one function of the media system comprises at least partially enabling (380) a remote control device (150, 160, 170) of the winner.

8. The method of claim 1, wherein:
the granting control of the at least one function of the media system comprises at least partially disabling (380) at least one remote control device (150, 160, 170) of at least one of the plurality of users other than the winner.

9. The method of claim 1, wherein:
the granting control of the at least one function of the media system comprises displaying a message (375) identifying the winner.

10. The method of claim 1, wherein:
the granting control of the at least one function of the media system comprises at least partially filtering out commands (385) from remote control devices (150, 160, 170) of the users other than the winner.

11. The method of claim 1, wherein:
the determining which of the plurality of users is a winner of the arbitration comprises arbitrarily selecting (350) one of the plurality of users as the winner.

12. The method of claim 1, wherein:
the determining which of the plurality of users is the winner comprises selecting one of the plurality of users that is fastest in responding to a prompt (355) as the winner.

13. The method of claim 1, wherein:
the determining which of the plurality of users is the winner comprises determining which of the plurality of users respond to a prompt in a defined time period, and arbitrarily selecting one of the plurality of users that responds to the prompt in the defined time period (360) as the winner.

14. The method of claim 1, wherein:
the arbitration comprises a game (340) in which the plurality of users participate, and a winner of the game is designated as the winner of the arbitration.

15. The method of claim 14, further comprising:
configuring (380) respective remote control devices (150, 160, 170) of the plurality of users for playing the game, responsive to the initiating of the arbitration.

16. The method of claim 14, wherein:
the game comprises a quiz, and the winner of the game is entitled to select a category of questions when the quiz is subsequently run to decide a subsequent arbitration for control of the media system.

17. The method of claim 14, further comprising:
selecting the game from among a plurality of available games based on at least one of a channel and a program being viewed by the plurality of users on the media system when the arbitration is initiated.

18. The method of claim 1, wherein:
the determining which of the plurality of users is the winner comprises designating the winner based on at least one of a number of times and an amount of time in the past (335) that the plurality of users have been granted control of the media system.

19. The method of claim 1, wherein:
the determining which of the plurality of users is the winner comprises designating the winner based on respective ages of the plurality of users.

20. The method of claim 1, wherein:
the determining which of the plurality of users is the winner comprises designating the winner based on respective ages of the plurality of users and a time of day.

21. The method of claim 1, wherein:
the media system (100) comprises at least one of a television, set-top box, and a DVD player, to which control is granted to the winner in the granting step.

22. At least one program storage device tangibly embodying instructions that are executable by at least one processor for performing a method for providing an interactive application on a media system for assigning control of the media system, comprising:
initiating an arbitration (320, 325) among a plurality of users of the media system (100);
determining which of the plurality of users is a winner of the arbitration; and
granting control (370) of at least one function of the media system to the user that is the winner of the arbitration.

23. A method for increasing interest among a plurality of users in a media system in which. content is available on a plurality of channels, comprising:
automatically initiating a vote (415) in which the plurality of users are prompted by the media system (100) to vote for a desired channel of the plurality of channels;
tallying the votes (425) to determine which of the plurality of channels won the vote, if any;
automatically switching the media system to the channel that won the vote (440), if any, responsive to the tallying; and
maintaining the media system on a current channel if none of the plurality of channels won the vote (445).

24. The method of claim 23, wherein:
the vote is automatically initiated by the media system at an arbitrary time (410).

25. A method for tracking interaction with a media system by a plurality of users, comprising:
displaying respective balances (505), on the display (140) of the media system, indicating respective allotments of commands which are allotted to each of the plurality of users for controlling the media system;
tracking commands (510) provided by each of the plurality of users; and
updating the displaying (515) of the respective balances according to the tracking of the commands to display a respective remaining balance of the respective allotment of commands for each of the plurality of users.

26. The method of claim 25, further comprising:
determining when all of the allotments of commands for the plurality of users have been exhausted (520); and
responsive to the determining, updating the displaying (515) of the respective balances to reflect additional respective allotments of commands which are allotted to each of the plurality of users for controlling the media system when all of the allotments of commands for the plurality of users has been exhausted.
